(19) United States
(12) Patent Application Publication
(10) Pub. No.: US 2001/0006416 A1
(43) Pub. Date: Jul. 5, 2001

(54) Ribbon flow cytometry apparatus and methods

(76) Inventor: Paul E. Johnson, Laramie, WY (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 09/770,883

(22) Filed: Jan. 26, 2001

Related U.S. Application Data
(63) Continuation-in-part of application No. 09/228,247, filed on Jan. 11, 1999.

(51) Int. Cl. G01N 21/00

(52) U.S. Cl. 356/73; 356/338

(57) ABSTRACT

Increased speed in the detection of target particles in flow cytometry is accomplished using two-dimensional detectors to detect target particles in a thin ribbon flow. The thickness of the ribbon flow of the sample stream is coordinated with the depth of field of the detection system optics, allowing a sharp image of the target particles. The width of the ribbon flow is coordinated with the field of view of the optics. The relatively large cross-sectional area of the flow in the ribbon flow chamber allows for a flow cytometer design not requiring a sheath flow. Signal-to-noise ratio (SNR) is greatly improved by using time delayed integration (TDI) in conjunction with the ribbon flow illumination to lower background noise from unwanted photons and CCD readout noise.

### CROSS-REFERENCE TO RELATED APPLICATIONS

This application is a continuation in part of copending U.S. patent application Ser. No. 09/228,247, filed Jan. 11, 1999, and entitled “Improved Flow Cytometry Apparatus and Methods,” which is incorporated herein by reference.

### BACKGROUND OF THE INVENTION

1. Field of the Invention

This invention relates to apparatus and methods for the detection of target particles in flow cytometry. In particular, the present invention relates to cytometry apparatus and methods based on the use of a two-dimensional CCD (charge coupled device) detector to detect microorganisms (or other target particles) in a relatively thin ribbon of flow of the sample stream (or “ribbon flow”).

2. Description of the Prior Art

Several monographs describe the methods and applications of flow cytometry (e.g., Flow Cytometry: First Principles by A. L. Givan, 1992, and references therein). The method provides a means of identifying and sorting single cells of a variety of types. The essential properties of microorganisms, or fluorescence from microorganisms themselves or the fluorescent labels placed onto or into the microorganisms before their delivery to the detection region. Usually, a small constant-velocity pump is used for generating the sample flow. Gravity could also be used. Irradiation is typically accomplished using a gas laser (such as an Ar or HeNe laser) or laser diode; selection of the fluorescence and rejection of the excitation beam are accomplished with a combination of filters, dichroic mirrors and beamsplitters; and detection is made with a photomultiplier tube or photodiode. One response of each microorganism (or target particle) consists of a burst of fluorescence photons generated during its passage through the irradiated region. Another consists of light scattering of photons in the illumination beam by the target particle, with an angular dependence characteristic of the size and shape of the target particle and a spectral dependence characteristic of the type of target particle. The successful detection of single organisms relies on several critical factors. First, the laser power must be sufficient to generate a large enough number of fluorescence (or alternatively, scattering) photons during the brief passage of the labeled bacterium through the irradiated region. Specifically, it is essential that the number of photons generated be large enough so that the fluorescence burst can be reliably differentiated from random fluctuations in the number of background photons. Second, reducing the background noise is important, i.e., minimizing the number of unwanted photons that strike the detector, arising from scattering and fluorescence from impurities in the flowing fluid and from the apparatus. FIG. 1 (prior art) shows a typical flow cytometry system (from Shapiro, Practical Flow Cytometry, 2nd Edition). The solution to be analyzed is in the core flow; the sheath flow serves to confine the core flow to a small diameter column, while inhibiting clogging of the core flow. A laser induces fluorescence from each microorganism in the core flow, which can be detected by a photomultiplier or photodiode (not shown). A small bore core flow allows for precision photometric measurements of cells in the flow illuminated by a small diameter laser beam; all of the cells will pass through nearly the same part of the beam and will be equally illuminated.

A fundamental difficulty with flow cytometry is embodied in the competing requirements of high flow rates, to provide reasonable sample throughput (necessary for fast detection of microorganisms), and high detectivity. High detectivity is predicated on having a fluorescing (or scattering) microorganism (or other target particle) in the detection beam long enough to provide a high signal-to-noise ratio (SNR) signal for detection, and having an optical design that will limit background noise from unwanted scattering and unwanted fluorescence. The optimal device is a flow cytometer with a small illumination beam, a high flow rate, and detection electronics that allow for collection of enough photons from a microorganism for high accuracy detection. Time delayed integration with a CCD camera or spectrophotometer can provide such a scenario.

The time delayed integration (TDI) technique was first discussed by Barbe (p. 659-671, Solid State Imaging, ed. P. G. Jespers, 1975) and developed by Wright and Mackay for astronomy (p. 160, SPIE Vol. 290, Solid State Imagers for Astronomy, 1981).

Conventionally, a CCD image is made by opening a shutter, exposing the CCD to an image, closing the shutter, and reading the device. A charge distribution then exists across the CCD, with each pixel carrying an electronic charge proportional to the light having fallen on that pixel during the exposure.

FIG. 2 (prior art) (is this really prior art?) is a conceptual drawing of a conventional CCD (after a TI 4849) (from Gillam et al., PASP, 104, 278-284, 1992). This CCD is a surface conduction device. The pixels form a 2-D imaging area and a 1-D serial register is used to transfer charge from the light sensitive imaging area to the output amplifier. The direction of pixel charge motion is from left to right (along a column) into the serial register (one row at a time), and then down the serial register to the output transistor that converts each charge to a voltage. With time delayed integration charge is shifted toward the serial register in synchronization with the motion of the image (or spectrum) across the CCD.

After the exposure, the charge is transferred, row by row, into a serial transport register. After each row transfer, the individual pixels are transferred, one at a time, through an on-chip output amplifier and digitized. The readout and digitization are generally performed as quickly as possible, under existing noise constraints.

The use of TDI in flow cytometry was taught in U.S. patent application Ser. No. 09/228,247, filed Jan. 11, 1999, by the present inventor. With the TDI technique, each row is shifted more slowly than is normal, to synchronize the pixel shift rate with the rate at which the image moves across the CCD. The CCD is not shuttered, but is read out continuously. Image smearing is avoided by mechanically (or by other means) moving the image across the CCD at the same rate that the CCD charge is being shifted. The charge in each pixel that is read out will have dwelt for an equal period on each pixel in one column of the CCD. This means that all of the image pixels read from a single column will have been detected with nearly equal quantum efficiency—the mean quantum efficiency of a CCD column.

FIG. 3 (prior art) shows that the use of a CCD camera or spectrophotometer with TDI to detect the bacterial fluorescence (or scattering) signal can reduce the unwanted scattered light problem spatially by detecting only those photons emitted from volumes around individual microorganisms. CCD spectrophotometry (not mentioned in the claims) also uniquely allows for spectral detection and discrimination of multiple species of microorganisms and/or multiple microorganisms of the same strain in the flow cell at one time.

Returning to FIG. 3, the improvement of SNR with imaging TDI is illustrated as follows. Left panel: two bacteria are shown in the core flow illuminated by a laser beam from the left. Right panel: the image, at the CCD surface, where pixels illuminated by the two previous bacteria are shown. The charge packets associated with these bacteria are shifted down the CCD (along the column or y-direction) at the same rate as the bacteria move in the cytometer flow (assuming a magnification of unity). The result is that a moving volume 9 μm×9 μm×50 μm is imaged onto the CCD and read out as a pixel. Using a single detector, such as a conventional photomultiplier tube, a volume 200 μm×50 μm×50 μm is detected. This would produce the same intensity contribution from the bacterium as would a CCD, but with more than 100 times the background intensity. (Note that in this figure the column direction is along the y-axis and the serial register would be located along the bottom edge of the CCD. In FIG. 2 the column direction is along the x-axis and the serial register is along the right-hand edge of the CCD.)

The main source of noise in a flow cytometer is the high level of laser emission scattered by the solvent, particles in the flow, and the instrument itself. A notch filter at the laser line frequency will reduce the intensity of this background by ˜10⁵, but even then fluorescence from unbound dye molecules can dominate bacterial fluorescence in a single detector immunofluorescence flow cytometer. In conventional flow cytometry this is addressed by illuminating and collecting light from a very small region of the flow. TDI achieves the same result without the need to restrict the illuminated volume. A much larger illuminated volume may be used, resulting in a longer residence time for each bacterium in the beam and a larger number of collected signal photons.

TDI allows one to image small volumes surrounding individual bacteria without knowing exactly where the bacteria reside in the cytometer flow. If the emission of a laser-illuminated flow cell is imaged onto a CCD with the flow direction aligned with the column direction of the chip, the CCD may be read out at a rate such that the fluorescence emission from a single bacterium always accumulates in a single moving charge packet in the chip (or a small group of neighboring charge packets). In the best case, emitted light from a single bacterium will reside in a single pixel. Otherwise, emitted light from the bacterium will reside in a larger group of neighboring pixels. The benefit of TDI CCD imaging over a single pixel detector is that the contribution of background photons from scattered light and fluorescing unbound dye molecules can be limited to a small region surrounding a bacterium, decreasing it by several orders of magnitude, depending on the cross section, the CCD pixel size, and the magnification of the system.

While TDI works well, there remains a need to increase speed in the detection of microorganisms in flow cytometry.

### SUMMARY OF THE INVENTION

An object of the present invention is to increase speed in the detection of target particles in flow cytometry. This object is accomplished by using a two-dimensional detector to detect target particles in a thin ribbon flow.

The thickness of the ribbon flow of the sample stream is coordinated with the depth of field of the detection system optics, allowing a sharp image of the target particles. The objective in this is to hold the spot size of target particles to a minimum, reducing the contribution of unwanted background illumination to any pixel(s) in which the target particles are registered.

The width of the ribbon flow is coordinated with the field of view of the imaging and detection optics, allowing imaging of the entire width of the flow stream.

Signal-to-noise ratio (SNR) is greatly improved by using time delayed integration (TDI) in conjunction with the ribbon flow illumination to lower background noise from unwanted photons and CCD readout noise. If TDI is used, the CCD is synchronized to the flow rate such that the time taken to read one frame of the CCD corresponds to the mean time taken by the target particles to pass through the field of view of the CCD.

The essential components of this invention are:

1. A flow chamber with an elongated (typically rectangular) ribbon flow cross section,

2. A laser or other means of illumination for illuminating a cross section of the ribbon flow from the side,

3. A detector such as a CCD camera for imaging the target particles in the illuminated cross section. Preferably, the CCD operates in TDI mode to increase the signal-to-noise ratio of detection.

4. Optics (e.g. optical fibers, lenses, mirrors, etc.) for imaging the target particles in the illuminated cross section onto a detector.

The elongated cross section results in an increase in the sample throughput in the flow cytometer while maintaining a long microorganism residence time in the illuminating beam. This allows a sample of given volume to be measured more rapidly.

The relatively large cross-sectional area of the flow in the ribbon flow chamber allows for a flow cytometer design not requiring a sheath flow. In fact, the flow chamber can be enclosed on all sides perpendicular to the flow, allowing for a simpler cytometer design. This is permitted because of the larger-than-conventional core cross section, allowing for a device which is not readily clogged by small particles.

### BRIEF DESCRIPTION OF THE DRAWINGS

FIG. 1 (prior art) is a schematic drawing showing a conventional flow cytometry system.

FIG. 2 (prior art) is a schematic drawing showing a conventional CCD detector.

FIG. 3 (prior art) is a schematic drawing showing the improvement of signal-to-noise ratio (SNR) in cytometers with imaging TDI and a sheathless (not entrained in a sheath flow) ribbon flow geometry.

FIG. 4 is a simplified schematic drawing showing the improved ribbon flow cytometry system of the present invention.

FIG. 5 is a flow diagram illustrating the illuminated cross section in the 1-dimensional flow of a conventional cytometry system and the illuminated cross section in the 2-dimensional flow of the improved cytometry system of FIG. 4.

FIG. 6 is a side view showing a ribbon flow cytometer and imaging apparatus according to the present invention.

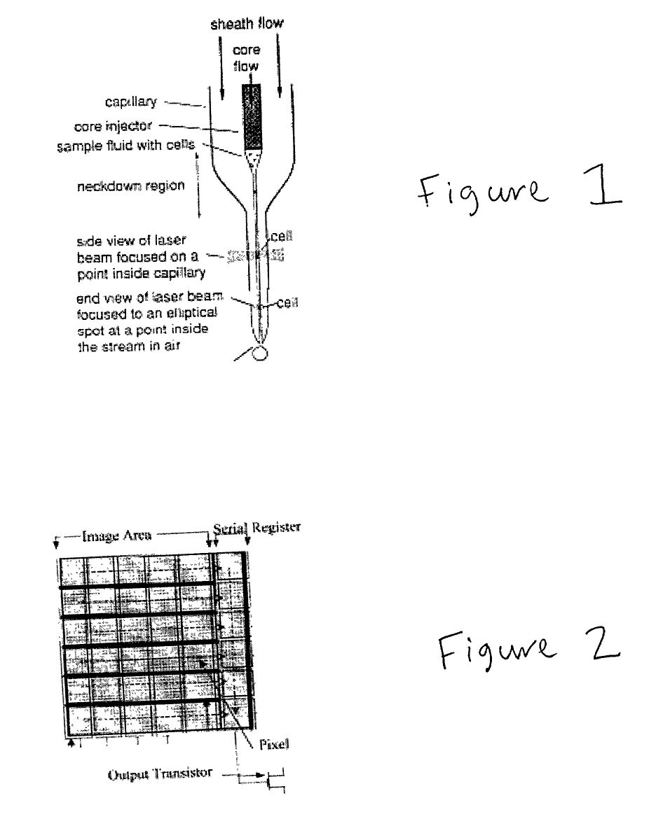

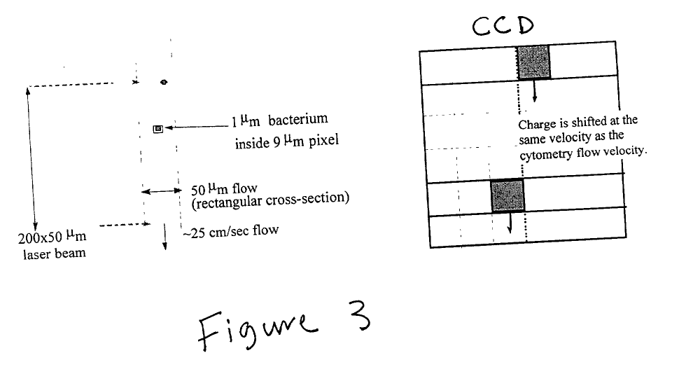

### DETAILED DESCRIPTION OF THE PREFERRED EMBODIMENTS

The flow conditions in a flow cytometry experiment are extremely important. They have been discussed in considerable detail (Pinkel & Stovel, “Flow Chambers and Sample Handling”; in Flow Cytometry: Instrumentation and Data Analysis, ed. by Van Dilla et al., 1985). The flow conditions in the improved TDI ribbon flow cytometer of the present invention are discussed here.

In a normal flow cytometer geometry, the core diameter determines the volume of the background solution illuminated with the laser and viewed by the detection system. Thus, it is related to the length of time that the target particle is within the laser beam (the transit time). This is important because the residual, unbound fluorescent tag in this volume of solution contributes to the number of background photons collected by the detection system. If this number is much larger than the number of photons detected from a target particle, the signal-to-noise ratio (SNR) will be very small, and the detection will be impossible. Thus, the core diameter and the transit time jointly conspire to determine the SNR for the detection of the target particle.

The critical quantity that determines both the core diameter and the transit time is the flow rate. This is typically given as the core volumetric flow rate, q, in ml/s. This is related to the cross sectional area of the core, A, in cm², and the flow velocity, v, in cm/s by the following equation:

q=Av.

The volumetric flow rate, or the sample throughput of the device, is proportional to the cross sectional area of the core flow. Simply increasing the diameter of a flow with a circular or square cross section will increase the volumetric flow rate, but also decreases the illumination intensity on particles in the flow, for a laser beam of given power. For a flow with a rectangular cross section, however, the illumination intensity can be maintained while increasing the volumetric flow rate. If the core flow cross section is characterized by a depth, z, and a width, x, (with z<x) then A=zx.

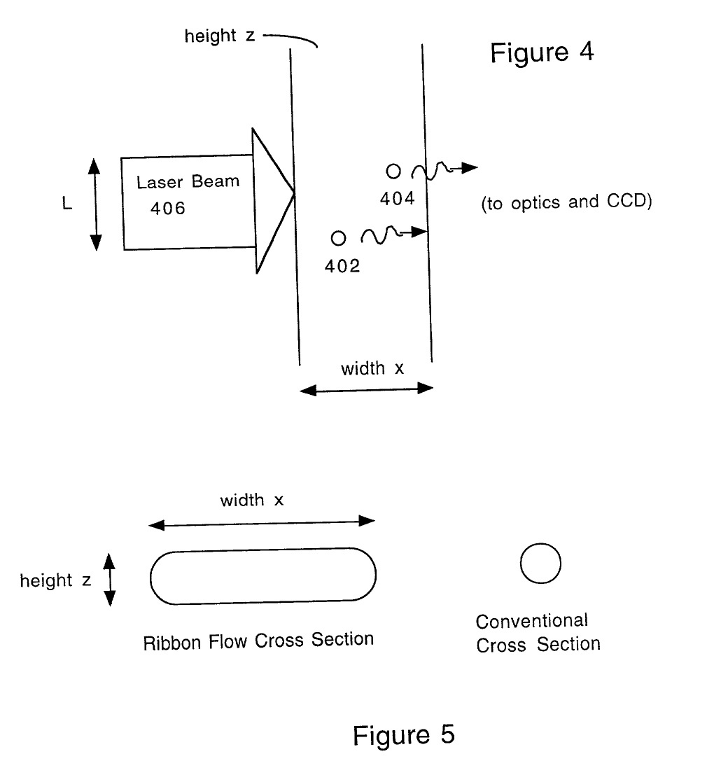

FIG. 4 is a simplified schematic drawing showing the improved ribbon flow cytometry system of the present invention. Two bacteria 402, 404 in the flow are illuminated by a rectangular laser beam 406 and caused to fluoresce. The bacteria are imaged onto the pixels of a CCD (not shown, see FIG. 6).

For a transparent fluid illuminated by laser beam 406, having length L and width z, incident on the core flow, the volumetric flow rate can be increased by increasing the width, x, of the core flow, without significantly decreasing the radiation density in the flow. As an example, laser beam 406 might have length L of 200 μm and width z of 50 μm. Increasing z, the depth of the core flow, would also increase the volumetric flow rate but would require increasing the width (z) of the laser beam (so that it fully illuminates the core flow). For a laser of given power this would require a decrease in the intensity of illumination of bacteria in the core flow.

The core ribbon flow (which may or may not be entrained in a sheath flow) is illuminated from the left side by rectangular laser beam 406. This side-illumination provides a higher photon density in the core flow than a back illumination, and a roughly uniform illumination over the illuminated core flow region if the fluid is nearly transparent. The flow within the flow chamber needs to be laminar in order for TDI to be used to maximize SNR. The resulting microorganism fluorescence can then be imaged directly by a camera incorporating filters for wavelength selection, as shown in FIG. 6.

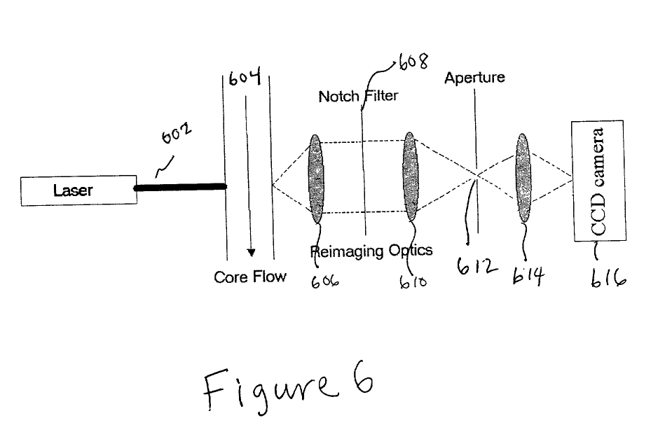

FIG. 5 is a diagram illustrating the illuminated cross section in the 1-dimensional flow of a conventional cytometry system and the illuminated cross section in the 2-dimensional flow of the improved cytometry system of FIG. 4. The cross section of the conventional 1-dimensional flow (on the right) is compared to the cross section of the 2-dimensional flow of the present invention, on the left. Referring back to FIG. 4, the 2-dimensional core flow has a rectangular cross section of z by x and is fully illuminated by a laser beam of dimension L by z.

Note that the ribbon flow cross section of the present invention has a distinct advantage in that it does not require a surrounding sheath flow (though a sheath flow may be used if desired). The conventional flow on the right must be entrained in a sheath flow which forces it into the required tiny cross section, because simply forcing the flow into a tube having the required tiny cross section would result in frequent clogging. The ribbon flow cross section of the present invention, however, can be confined by the boundaries of a transparent tube. This is called a “sheathless ribbon flow.”

FIG. 6 is a side view showing a ribbon flow cytometer 600 according to the present invention. Laser 602 illuminates core flow 604 from the left. Notch filter 608 attenuates scattered light at the illuminating wavelength to reduce noise (the fluorescing wavelength(s) are transmitted). Imaging optics 606, 610, and 614 image the particles through aperture (field stop) 612 onto CCD camera 616.

The depth of the flow (z in FIGS. 4 and 5) is chosen to match the depth of field achieved by the imaging and detection optics of system 600 (or vice versa). Similarly, the width of the flow (x in FIGS. 4 and 5) is chosen to match the field of view of the imaging and detection optics (or vice versa).

If TDI is used, CCD 616 is synchronized to the flow rate such that the time taken to read one frame of CCD 616 equals the mean time taken by the target particles to pass through the field of view of the CCD. FIG. 3 and the paragraphs associated with FIG. 3 describe this operation in detail.

While the above description has focused on the detection of particles such as microorganisms using fluorescent labels, those skilled in the art will appreciate that the present invention is not limited to microorganisms or fluorescence measurements. For example, it would be possible to apply the same technique to the detection of single molecules through fluorescence or Raman scattering in a flow cytometer. TDI would still significantly enhance the SNR of each detection by decreasing the background component from the surrounding medium. This technology could be used to detect explosives and groundwater contaminants, for example.

What is claimed is:

1. Apparatus for identifying particles in a sample stream moving through a flow zone at a flow rate relative to the flow zone, the sample stream containing target particles, the apparatus comprising:
means for forming the sample stream within the flow zone into a ribbon flow (having an elongated cross section);
means for illuminating the sample stream within the flow zone; and
a detector for detecting light emitted or scattered from illuminated target particles within the flow zone.

2. The apparatus of claim 1, wherein the illuminating means is a laser.

3. The apparatus of claim 2, wherein the laser is constructed and arranged to illuminate the flow zone such that the illumination passes through the flow zone parallel to the elongated cross section.

4. The apparatus of claim 1 wherein the elongated cross section is rectangular.

5. The apparatus of claim 1, further including:
a time delayed integration element for integrating the detected light, the time delayed integration synchronized to the sample stream flow rate; and
means for identifying target particles responsive to the time delayed integration element.

6. The apparatus of claim 5 wherein the detector comprises a charge coupled device (CCD).

7. The apparatus of claim 6, wherein the time delayed integration element includes means for shifting CCD pixel rows in synchronization with the sample stream flow rate.

8. The apparatus of claim 7 wherein the means for identifying target particles includes means for reading pixels the CCD one row at a time.

9. The apparatus of claim 1, further including a notch filter between the sample stream and the detector for filtering out undesired light.

10. The apparatus of claim 1, wherein the means for forming the sample stream within the flow zone into a ribbon flow having an elongated cross section is a tube.

11. The apparatus of claim 1, wherein the means for forming the sample stream within the flow zone into a ribbon flow is an entraining sheath flow.

12. The apparatus of claim 1 wherein the detector comprises a charge coupled device (CCD).

13. The apparatus of claim 1 wherein the detector comprises an electronic imaging device.

14. The apparatus of claim 1, further including means for measuring the sample stream flow rate including:
a calibration particle in the sample flow; and
means for measuring the velocity of the calibration particle.

15. The apparatus of claim 14, wherein the sample stream rate is measured in real time while target particles are being detected.

16. The apparatus of claim 14 wherein the calibration particle is a target particle.

17. The apparatus of claim 16, wherein the sample stream rate is measured in real time while target particles are being detected.

18. The apparatus of claim 1, further including means for measuring the sample stream flow rate including:
means for applying statistical analysis to data collected by the pixels of the CCD to determine pixels related to a single target particle; and
means for measuring velocity of at least one target particle.

19. The apparatus of claim 1, further including means for synchronizing the time delayed integration element and the sample stream flow rate by adjusting the time delayed integration element until target particles appear substantially as dots.

20. The apparatus of claim 1, further including means for detecting two or more different target particle species, wherein each species produces a unique frequency or phase shift in its scattered or emitted light, wherein the detector includes means for differentiating frequency or phase shift.

21. Apparatus for identifying particles in a sample stream moving through a flow zone at a flow rate relative to the flow zone, the sample stream containing target particles, the apparatus comprising:
means for forming the sample stream within the flow zone into a ribbon flow having an elongated cross section;
a laser for illuminating the sample stream within the flow zone, the laser constructed and arranged to illuminate the flow zone such that the illumination passes through the flow zone parallel to the elongated cross section;
a detector for detecting light emitted or scattered from illuminated target particles within the flow zone;
a time delayed integration element for integrating the detected light, the time delayed integration synchronized to the sample stream flow rate; and
means for identifying target particles responsive to the time delayed integration element.

22. A method for identifying particles in a sample stream moving through a flow zone at a flow rate relative to the flow zone, the sample stream containing target particles, the method comprising the steps of:
forming the sample stream within the flow zone into a ribbon flow (having an elongated cross section);
illuminating the sample stream within the flow zone; and
detecting light emitted or scattered from illuminated target particles within the flow zone.

23. The method of claim 22, wherein the illuminating step illuminates the flow zone such that the illumination passes through the flow zone parallel to the elongated cross section.

24. The apparatus of claim 22, further including the steps of:
time delayed integrating the detected light, the time delayed integration synchronized to the sample stream flow rate; and
identifying target particles responsive to the time delayed integration element.

25. The method of claim 24 wherein the detection step is accomplished using a charge coupled device (CCD), and wherein the time delayed integration step includes the step of shifting CCD pixel rows in synchronization with the sample stream flow rate.
